(19) United States
(12) Patent Application Publication
(10) Pub. No.: US 2019/0346548 A1
(43) Pub. Date: Nov. 14, 2019

(54) FILTERING TO ADDRESS RANGE WALK EFFECT IN RANGE-DOPPLER MAP

(71) Applicant: GM Global Technology Operations LLC, Detroit, MI (US)

(72) Inventors: Gonen Barkan, Lehavim (IL); Ishai Eljarat, Raanana (IL); Igal Bilik, Rehovot (IL); Oren Longman, Tel Aviv (IL)

(21) Appl. No.: 15/977,405

(22) Filed: May 11, 2018

(51) Int. Cl. G01S 13/524; G01S 13/89; G01S 13/58; G01S 7/288

(52) U.S. Cl. CPC G01S 13/5242; G01S 13/89; G01S 2007/2883; G01S 7/288; G01S 13/582

(57) ABSTRACT

A radar system and method of processing one or more return signals obtained by a receive section of a radar system resulting from transmitting one or more signals involve a transmit section to transmit the one or more signals, and a receive section to receive the one or more return signals resulting from reflection of the one or more signals by a target. The system also includes a processor to process the one or more return signals using a two-stage fast Fourier transform (FFT) to obtain a range-Doppler map indicating energy levels at each of a set of range values and a set of Doppler values, to filter the range-Doppler map using a kernel sized according to an estimate of a number of the set of range values over which the energy levels above a threshold value are spread, and to perform target detection based on a result of filtering.

### INTRODUCTION

The subject disclosure relates to filtering to address the range walk effect in a range-Doppler map.

Vehicles (e.g., automobiles, trucks, farm equipment, construction equipment, automated factory equipment) increasingly include sensors to facilitate augmentation or automation of vehicle operation. Exemplary sensors include radio detection and ranging (radar) systems, light detection and ranging (lidar) systems, cameras, and microphones. A radar system may make use of the Doppler effect to determine relative velocity of a detected target along with its range. The Doppler effect refers to the shift in transmitted frequency evident in a return signal (i.e., received signal) resulting from reflection by a target. The processing of received signals to obtain information about a target such as relative position, range, and velocity, involves developing a range-Doppler map that indicates the received energy in each of several range bins and each of several Doppler bins. Based on target speed, however, the range-Doppler map may be affected by a phenomenon referred to as range walk, in which energy reflected by a target is spread over multiple range bins. Accordingly, it is desirable to provide filtering to address the range walk effect in a range-Doppler map.

### SUMMARY

In one exemplary embodiment, a radar system includes a transmit section to transmit one or more signals, and a receive section to receive one or more return signals resulting from reflection of the one or more signals by a target. The system also includes a processor to process the one or more return signals using a two-stage fast Fourier transform (FFT) to obtain a range-Doppler map indicating energy levels at each of a set of range values and a set of Doppler values, to filter the range-Doppler map using a kernel sized according to an estimate of a number of the set of range values over which the energy levels above a threshold value are spread, and to perform target detection based on a result of filtering.

In addition to one or more of the features described herein, a number Nchirps of the one or more signals is transmitted by the transmit section in one frame, and a number of samples Nsamples of each of the Nchirps signals is obtained.

In addition to one or more of the features described herein, the processor also determines integration time Tint as Tᵢₙₜ=Nₛₐₘₚₗₑₛ·Fₛ·N_{chirps}, where Fs is the frequency at which the number samples is obtained.

In addition to one or more of the features described herein, the processor also estimates a number of elements of the kernel as

$${N}_{cells} = [ \frac{{T}_{int} {R}_{samples}}{{R}_{ma x}} d ] ,$$

where the set of range values is from 0 to Rmax, which is a maximum unambiguous target range, Rsamples is a number of increments from 0 to Rmax, and d is a Doppler value within the set of Doppler values associated with the number of range values over which the energy levels above a threshold value are spread

In addition to one or more of the features described herein, each of the elements of the kernel has a value of 1/Ncells.

In addition to one or more of the features described herein, the processor also filters the range-Doppler map to obtain the result of the filtering by convolving the Rsamples number of energy levels associated with the Doppler value d with the Ncells number of elements of the kernel.

In addition to one or more of the features described herein, the radar system is a multi-input multi-output (MIMO) radar system.

In addition to one or more of the features described herein, the radar system is within or on a vehicle and is configured to detect a location and speed of an object relative to the vehicle.

In another exemplary embodiment, a method of processing one or more return signals obtained by a receive section of a radar system resulting from transmitting one or more signals includes performing a two-stage fast Fourier transform (FFT) to obtain a range-Doppler map indicating energy levels at each of a set of range values and a set of Doppler values. The method also includes filtering the range-Doppler map using a kernel sized according to an estimate of a number of the set of range values over which the energy levels above a threshold value are spread, and performing target detection using a result of the filtering.

In addition to one or more of the features described herein, the method also includes transmitting a number Nchirps of the one or more signals and obtaining a number of samples Nsamples of each of the Nchirps signals.

In addition to one or more of the features described herein, the method also includes determining integration time Tint as Tᵢₙₜ=Nₛₐₘₚₗₑₛ·Fₛ·N_{chirps}, wherein Fs is the frequency at which the number samples is obtained.

In addition to one or more of the features described herein, the method also includes estimating a number of elements of the kernel as

$${N}_{cells} = [ \frac{{T}_{int} {R}_{samples}}{{R}_{ma x}} d ] ,$$

wherein the set of range values is from 0 to Rmax, which is a maximum unambiguous target range, Rsamples is a number of increments from 0 to Rmax, and d is a Doppler value within the set of Doppler values associated with the number of range values over which the energy levels above a threshold value are spread, and setting a value of each of the elements of the kernel to 1/Ncells.

In addition to one or more of the features described herein, the filtering the range-Doppler map to obtain the result of the filtering includes convolving the Rsamples number of energy levels associated with the Doppler value d with the Ncells number of elements of the kernel.

In addition to one or more of the features described herein, the method also includes detecting a location and speed of an object relative to a vehicle based on the target detection.

In yet another exemplary embodiment, a vehicle includes a radar system that includes a transmit section to transmit one or more signals, and a receive section to receive one or more return signals resulting from reflection of the one or more signals by a target. The system also includes a processor to process the one or more return signals using a two-stage fast Fourier transform (FFT) to obtain a range-Doppler map indicating energy levels at each of a set of range values and a set of Doppler values, to filter the range-Doppler map using a kernel sized according to an estimate of a number of the set of range values over which the energy levels above a threshold value are spread, and to perform target detection based on a result of filtering. The vehicle also includes a controller to augment or automate operation of the vehicle based on the target detection.

In addition to one or more of the features described herein, a number Nchirps of the one or more signals is transmitted by the transmit section in one frame, and a number of samples Nsamples of each of the Nchirps signals is obtained, and the processor is further configured to determine integration time Tint as Tᵢₙₜ=Nₛₐₘₚₗₑₛ·Fₛ·N_{chirps}, where Fs is the frequency at which the number samples is obtained.

In addition to one or more of the features described herein, the processor estimates a number of elements of the kernel as

$${N}_{cells} = [ \frac{{T}_{int} {R}_{samples}}{{R}_{ma x}} d ] ,$$

where the set of range values is from 0 to Rmax, which is a maximum unambiguous target range, Rsamples is a number of increments from 0 to Rmax, and d is a Doppler value within the set of Doppler values associated with the number of range values over which the energy levels above a threshold value are spread.

In addition to one or more of the features described herein, each of the elements of the kernel has a value of 1/Ncells.

In addition to one or more of the features described herein, the processor filters the range-Doppler map to obtain the result of the filtering by convolving the Rsamples number of energy levels associated with the Doppler value d with the Ncells number of elements of the kernel.

In addition to one or more of the features described herein, the radar system is a multi-input multi-output (MIMO) radar system.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a scenario involving a radar system according to embodiments;

FIG. 2 is a block diagram of an exemplary radar system according to one or more embodiments;

FIG. 3 shows an exemplary range-Doppler map that is filtered according to one or more embodiments;

FIG. 4 shows an exemplary convolution process for a kernel obtained according to one or more embodiments;

FIG. 5 shows an exemplary range-Doppler map that undergoes filtering to address the range walk effect according to one or more embodiments; and

FIG. 6 shows the range-Doppler map that results from filtering to address the range walk effect in the range-Doppler map of FIG. 5 according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, a radar system may be one of several sensors that provides information to augment or automate vehicle operation. A radar may transmit a continuous wave or a series of pulses. For example, a radar system may transmit a frequency modulated continuous wave, referred to as a chirp, with a linear increase or decrease in frequency over the duration of the continuous wave. A radar system may include one or more transmitters and one or more receivers. For example, the radar system may be a multi-input multi-output (MIMO) system with multiple transmit channels and multiple receive channels. For explanatory purposes, the transmission of chirps in a MIMO radar system is discussed.

The processing of received signals, which result from the chirps being reflected by a target, is well-known and only generally outlined here. The typical processing of received reflections includes performing an analog-to-digital conversion and a fast Fourier transform (FFT) with respect to range (referred to as a range FFT). The result of the range FFT is an indication of energy distribution across ranges detectable by the radar for each chirp that is transmitted, and there is a different range FFT associated with each receive channel and each transmit channel. Thus, the total number of range FFTs is a product of the number of transmitted chirps and the number of receive channels.

A Doppler FFT is then performed on the range FFT result. The Doppler FFT is also a known process in radar detection and is used to obtain a range-Doppler map per receive channel. Because the range FFT and Doppler FFT are successively performed to obtain a range-Doppler map according to the exemplary embodiment, the process may be referred to as a two-stage FFT process. For each receive channel and transmit channel pair, all the chirps are processed together for each range bin of the range-chip map (obtained with the range FFT). The result of the Doppler FFT, the range-Doppler map, indicates the relative velocity of each detected target along with its range. The number of Doppler FFTs is a product of the number of range bins and the number of receive channels.

Digital beamforming results in a range-Doppler (relative velocity) map per beam. Digital beamforming is also a known process and involves obtaining a vector of complex scalars from the vector of received signals and the matrix of actual received signals at each receive element for each angle of arrival of a target reflection. Digital beamforming provides an azimuth angle to each of the detected targets based on a thresholding of the complex scalars of the obtained vector. The outputs that are ultimately obtained from processing the received signals are range, Doppler, azimuth, elevation, and amplitude of each target.

As previously noted, the range-Doppler map may evidence range walk. Because of range walk, in the Doppler bin (i.e., Doppler interval within the Doppler range covered by the range-Doppler map) associated with the relative velocity of a target, the energy is spread over multiple range bins. Specifically, the number of range bins with an energy level above a threshold value is greater due to the range walk effect. This is because the target speed is high enough that, during the duration of transmission of the series of chirps, the range to the target changes by greater than the range interval (e.g., 5 to 10 centimeters) covered by each range bin. Thus, the closer the Doppler bin associated with the target is to the maximum Doppler shown in range-Doppler map, the more prevalent the range walk issue. The range walk affects signal-to-noise ratio (SNR). This, in turn, affects the accuracy with which the angle of arrival (i.e. azimuth) of the target may subsequently be computed using beam forming.

Embodiments of the systems and methods detailed herein address the range walk in a range-Doppler map to increase the SNR and, consequently, the accuracy of the azimuth estimate. Specifically, a filter bank is designed based on the number of range bins over which the target response is spread. The result of filtering is a sharper response, concentrated in fewer range bins, that smooths out the effect of range walk in the range-Doppler map. The subsequent beam forming result provides a more accurate estimate of the azimuth angle to the target.

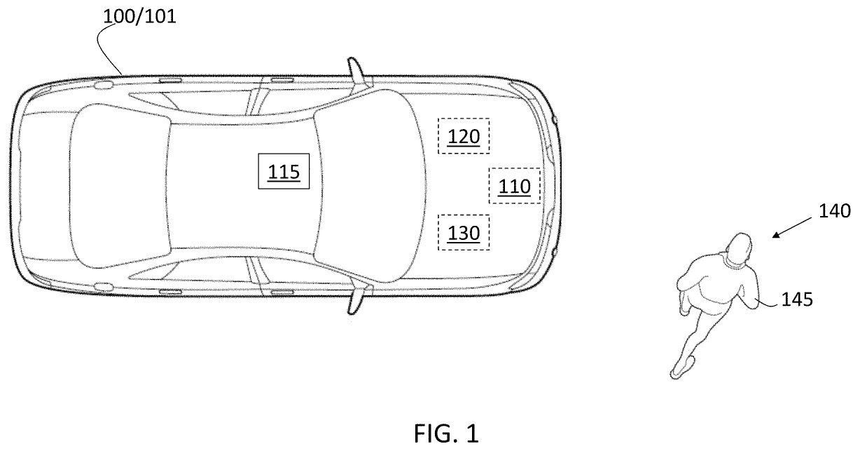

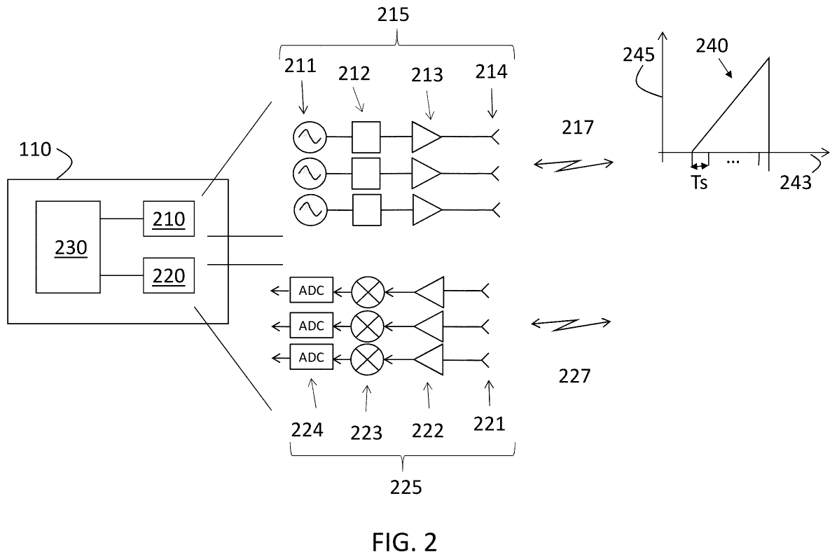

In accordance with an exemplary embodiment, FIG. 1 is a block diagram of a scenario involving a radar system 110. The vehicle 100 shown in FIG. 1 is an automobile 101. A radar system 110, detailed with reference to FIG. 2, is shown at the front of the automobile 101. According to alternate or additional embodiments, one or more radar systems 110 may be located elsewhere on the vehicle 100. Portions of the radar system 110 may be housed within or on the vehicle 100. Another sensor 115 (e.g., camera, microphone, lidar system) is shown, as well. Information obtained by the radar system 110 and one or more other sensors 115 may be provided to a controller 120 (e.g., electronic control unit (ECU)).

The controller 120 may use the information to control one or more vehicle systems 130. In an exemplary embodiment, the vehicle 100 may be an autonomous vehicle controlled, at least in part, by the controller 120. The radar system 110, alone or additionally with one or more other sensors 115, may be used to detect objects 140, such as the pedestrian 145 shown in FIG. 1. The controller 120 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

FIG. 2 is a block diagram of an exemplary radar system 110 according to one or more embodiments. The exemplary radar system 110 is a MIMO system. As such, there are multiple transmit channels 215 and receive channels 225. Generally, the radar system 110 includes a transmit section 210 associated with the transmit channels 215, a receive section 220 associated with the receive channels 225, and a radar controller 230. The radar controller 230 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The radar controller 230 may be housed with the radar system 110 or may be a vehicle controller 120 that performs functions additional to control of the radar system 110.

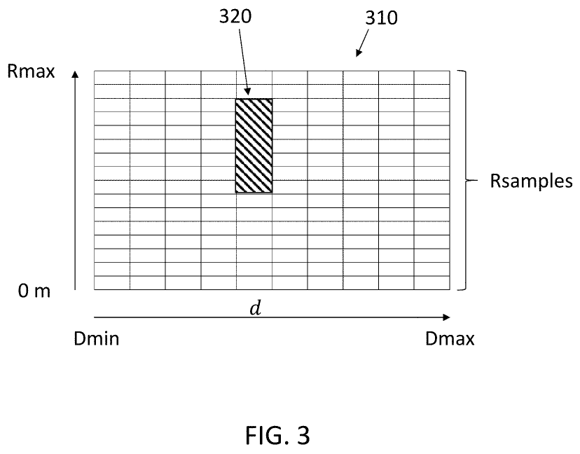

In the exemplary MIMO radar system 110 shown in FIG. 2, each of the transmit channel 215 includes an oscillator 211, a buffer 212, a power amplifier 213, and an antenna element 214. Each receive channel 225 includes an antenna element 221, a pre-amplifier 222, a mixer 223, and an analog-to-digital converter (ADC) 224. While only three transmit channels 215 and three receive channels 225 are shown, the radar system 110 may include any number of channels and may include a different number of transmit channels 215 than receive channels 225. Each transmit channel 215 emits a transmit signal 217 (e.g., chirp 240). If that transmit signal 217 encounters a target 140, then energy is reflected in the form of received signals 227. In the exemplary MIMO system, every receive channel 225 receives the received signals 227 generated by each transmit signal 217 of each transmit channel 215, as noted previously. The processing of the received signals 227 includes generating the range-Doppler map 310 (FIG. 3) and addressing range walk effects on the range-Doppler map 310 according to the embodiments detailed herein.

An exemplary chirp 240 is shown in FIG. 2. Time is shown along axis 243 and frequency is shown along axis 245. As FIG. 2 indicates, the exemplary chirp 240 has a linearly increasing frequency over the duration of the chirp 240. The chirp is sampled to obtain a number of samples indicated by Nsamples. The frequency of the sampling, Fs, is the inverse of the period of the samples Ts, indicated in FIG. 2. The number of chirps 240 transmitted by the transmit channels 215 in one frame is indicated by Nchirps. In the exemplary radar system 110 shown in FIG. 2, Nchirps may be three because there are three transmit channel 215 that would each transmit one chirp 240. The corresponding integration time Tint, which may also be referred to as the time on target 140, is given by:

Tᵢₙₜ=Nₛₐₘₚₗₑₛ·Fₛ·N_{chirps} [EQ. 1]

FIG. 3 shows an exemplary range-Doppler map 310 that is filtered according to one or more embodiments. As previously described, a different range-Doppler map 310 is associated with each receive channel 225. The exemplary range-Doppler map 310 has range values from 0 meters to Rmax, which is the maximum unambiguous target range, over 16 bins (referred to as Rsamples). The values of Nsamples and Rsamples may be the same. The range-Doppler map 310 also shows Doppler values from Dmin to Dmax meters per second (m/s) over 10 bins. For example, if Dmin is −5 m/s and Dmax is 4 m/s, each Doppler bin spans 1 m/s such that the 10 bins correspond to −5 m/s, −4 m/s, −3 m/s, −2 m/s, −1 m/s, 0 m/s, 1 m/s, 2 m/s, 3 m/s, and 4 m/s. The bin indicated as d corresponds with −1 m/s. According to the exemplary case, the energy indicated by the range-Doppler map 310, which is obtained from the received signals 227 as previously described, is spread over several range bins in the Doppler bin d. Specifically, the energy is predominantly spread over the 7 range bins that are indicated by 320. This spread over the 7 range bins indicated by 320 represents the range-walk phenomenon. According to embodiments detailed herein, the kernel developed to filter the range-Doppler map 310 will be sized according to an estimate of the number of range bins labeled as 320.

The estimate of the number of cells Ncells over which the range response (i.e., the range-Doppler map 310 values for the range bins in Doppler bin d) is spread is given by:

$${N}_{cells} = [ \frac{{T}_{int} {R}_{samples}}{{R}_{ma x}} d ] \qquad [ EQ . 2 ]$$

The value of Ncells is the size of the kernel and also forms the basis of the filter values. For example, the filter may be a mean filter and each of the Ncells number of filter values may be 1/Ncells. The filter may instead be a median or Gaussian filter with Ncells number of values. The convolution of the range response refers to a sliding window multiplication with the kernel. Any known convolution algorithm may be used such as zero padding, extrapolation, or circular or cyclic convolution, for example.

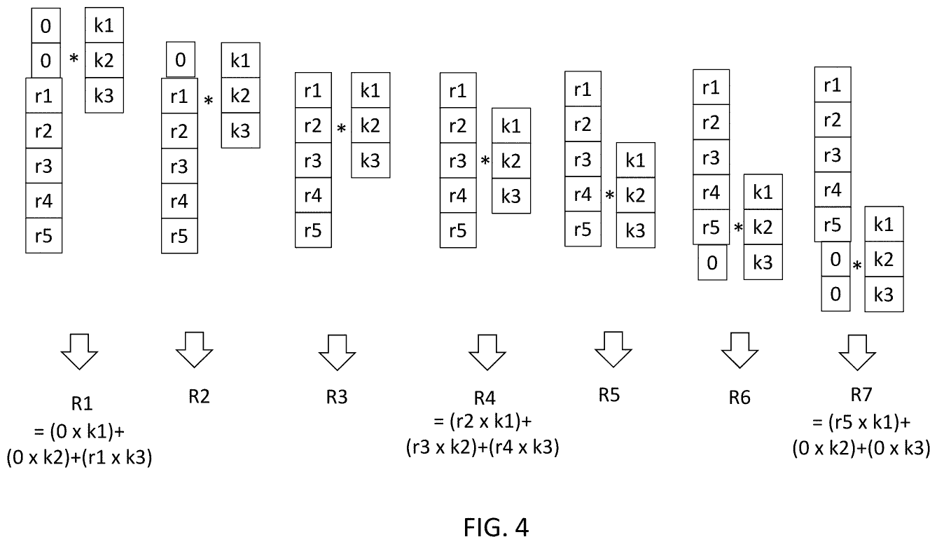

FIG. 4 shows an exemplary convolution process for a kernel obtained according to one or more embodiments. In the exemplary case, Rsamples (i.e., the number of range bins in the range-Doppler map 310) is five, and Ncells, determined according to EQ. 2, is three. The energy values in the five range bins are represented by r1, r2, r3, r4, r5. The three kernel values are represented by k1, k2, k3. As previously noted, the kernel values k1, k2, k3 may all be 1/Ncells (=⅓ in the example) in the exemplary case of a mean filter. The kernel values k1, k2, k3 may be set based on a median or Gaussian filter according to alternate embodiments. A zero-padding convolution is shown in the exemplary case. As FIG. 4 indicates, seven values (R1-R7) result from the sliding window operation that represents filtering of the range bins associated with the Doppler bin d exhibiting the range-walk phenomenon. Computations are detailed for R1, R4, and R7, for explanatory purposes. The seven values R1 through R7, rather than the original five values r1 through r5, are used for to more accurately detect the range to the target 140.

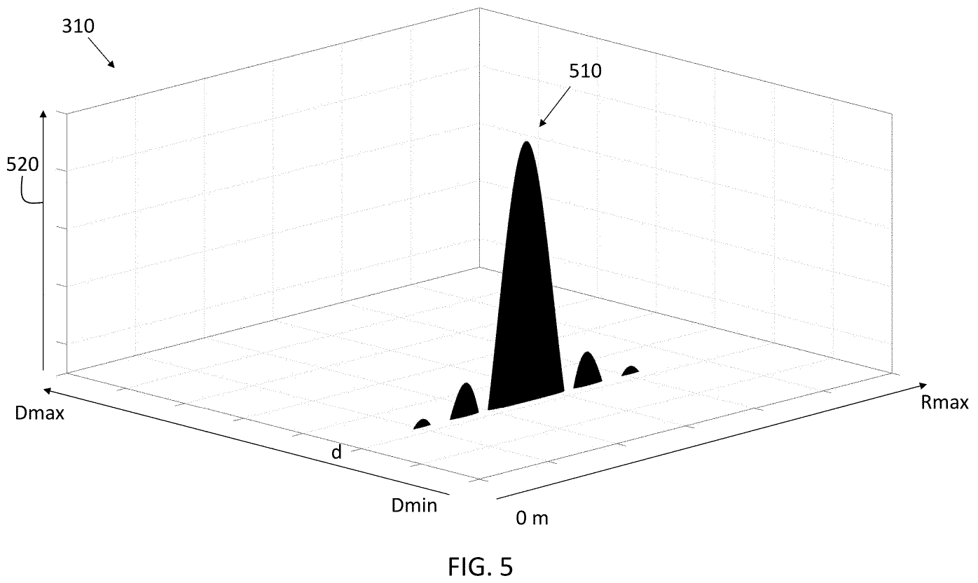

FIG. 5 shows an exemplary range-Doppler map 310 that undergoes filtering to address the range walk effect according to one or more embodiments. Energy is indicated along axis 520. As FIG. 5 indicates, the range bins associated with the Doppler bin d include the peak 510. The energy detected at other Doppler bins is not shown for simplicity. This energy, which does not result from reflection by a target 140, may be referred to as the noise floor. The Doppler bin d is identified based on the energy levels along range bins associated with Doppler bin d exceeding a threshold value (e.g., a value above the noise floor). According to one or more embodiments, the Ncells is computed based on EQ. 2. As previously noted, Ncells is the estimate of the number of range bins over which the range response is spread and is also the number of kernels that are used to filter the range bins associated with Doppler bin d.

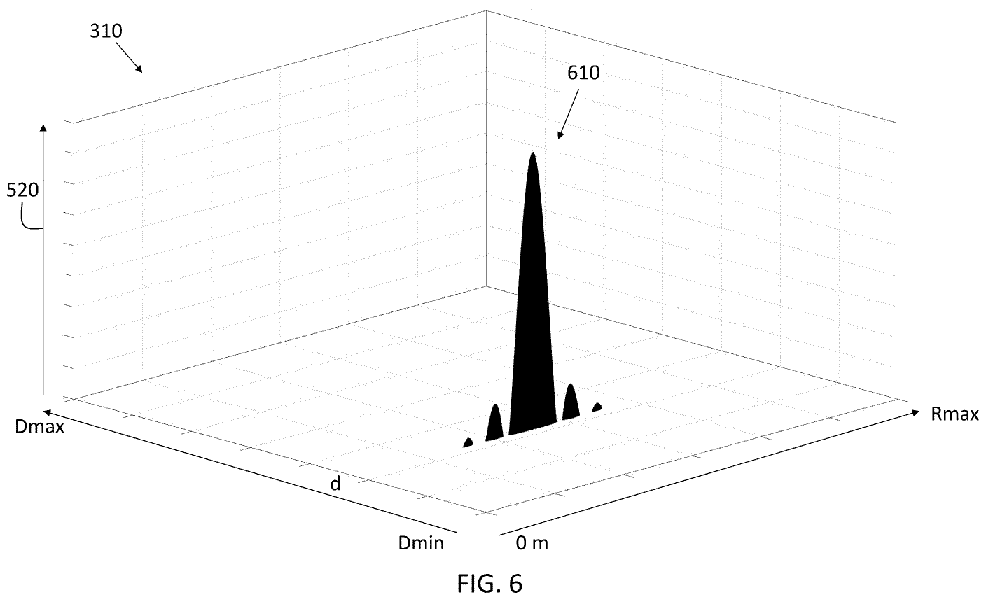

FIG. 6 shows the range-Doppler map 310 that results from filtering to address the range walk effect in the range-Doppler map 310 of FIG. 5 according to one or more embodiments. In FIG. 6, the range bins associated with Doppler bin d include the peak 610. A comparison of FIG. 5 and FIG. 6 indicates that the base of the peak 510 in FIG. 5 is spread more than the base of the peak 610 in FIG. 6. Using the range-Doppler bin 310 shown in FIG. 6 to determine the range from the radar system 110 to the target 140 (i.e., the target 140 that results in the peaks 510 (FIG. 5) and 610) results in a more accurate estimate than if the range-Doppler map 310 of FIG. 5 were used. This is because of the range-walk phenomenon evidenced in the range-Doppler map 310 shown in FIG. 5.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A radar system, comprising:
a transmit section configured to transmit one or more signals;
a receive section configured to receive one or more return signals resulting from reflection of the one or more signals by a target; and
a processor configured to process the one or more return signals using a two-stage fast Fourier transform (FFT) to obtain a range-Doppler map indicating energy levels at each of a set of range values and a set of Doppler values, to filter the range-Doppler map using a kernel sized according to an estimate of a number of the set of range values over which the energy levels above a threshold value are spread, and to perform target detection based on a result of filtering.

2. The radar system according to claim 1, wherein a number Nchirps of the one or more signals is transmitted by the transmit section in one frame, and a number of samples Nsamples of each of the Nchirps signals is obtained.

3. The radar system according to claim 2, wherein the processor is further configured to determine integration time Tint as:
Tᵢₙₜ=Nₛₐₘₚₗₑₛ·Fₛ·N_{chirps}, where
Fs is the frequency at which the number samples is obtained.

4. The radar system according to claim 3, wherein the processor is further configured to estimate a number of elements of the kernel as:
$${N}_{cells} = [ \frac{{T}_{int} {R}_{samples}}{{R}_{ma x}} d ] ,$$
the set of range values is from 0 to Rmax, which is a maximum unambiguous target range, Rsamples is a number of increments from 0 to Rmax, and d is a Doppler value within the set of Doppler values associated with the number of range values over which the energy levels above a threshold value are spread.

5. The radar system according to claim 4, wherein each of the elements of the kernel has a value of 1/Ncells.

6. The radar system according to claim 4, wherein the processor is configured to filter the range-Doppler map to obtain the result of the filtering by convolving the Rsamples number of energy levels associated with the Doppler value d with the Ncells number of elements of the kernel.

7. The radar system according to claim 1, wherein the radar system is a multi-input multi-output (MIMO) radar system.

8. The radar system according to claim 1, wherein the radar system is within or on a vehicle and is configured to detect a location and speed of an object relative to the vehicle.

9. A method of processing one or more return signals obtained by a receive section of a radar system resulting from transmitting one or more signals, the method comprising:
performing a two-stage fast Fourier transform (FFT) to obtain a range-Doppler map indicating energy levels at each of a set of range values and a set of Doppler values;
filtering the range-Doppler map using a kernel sized according to an estimate of a number of the set of range values over which the energy levels above a threshold value are spread; and
performing target detection using a result of the filtering.

10. The method according to claim 9, further comprising transmitting a number Nchirps of the one or more signals and obtaining a number of samples Nsamples of each of the Nchirps signals.

11. The method according to claim 10, further comprising determining integration time Tint as:
Tᵢₙₜ=Nₛₐₘₚₗₑₛ·Fₛ·N_{chirps}, wherein
Fs is the frequency at which the number samples is obtained.

12. The method according to claim 11, further comprising estimating a number of elements of the kernel as:
$${N}_{cells} = [ \frac{{T}_{int} {R}_{samples}}{{R}_{ma x}} d ] ,$$
the set of range values is from 0 to Rmax, which is a maximum unambiguous target range, Rsamples is a number of increments from 0 to Rmax, and d is a Doppler value within the set of Doppler values associated with the number of range values over which the energy levels above a threshold value are spread, and setting a value of each of the elements of the kernel to 1/Ncells.

13. The method according to claim 12, wherein the filtering the range-Doppler map to obtain the result of the filtering includes convolving the Rsamples number of energy levels associated with the Doppler value d with the Ncells number of elements of the kernel.

14. The method according to claim 9, further comprising detecting a location and speed of an object relative to a vehicle based on the target detection.

15. A vehicle, comprising:
a radar system, comprising:
a transmit section configured to transmit one or more signals;
a receive section configured to receive one or more return signals resulting from reflection of the one or more signals by a target; and
a processor configured to process the one or more return signals using a two-stage fast Fourier transform (FFT) to obtain a range-Doppler map indicating energy levels at each of a set of range values and a set of Doppler values, to filter the range-Doppler map using a kernel sized according to an estimate of a number of the set of range values over which the energy levels above a threshold value are spread, and to perform target detection based on a result of filtering; and
a controller configured to augment or automate operation of the vehicle based on the target detection.

16. The vehicle according to claim 15, wherein a number Nchirps of the one or more signals is transmitted by the transmit section in one frame, and a number of samples Nsamples of each of the Nchirps signals is obtained, and the processor is further configured to determine integration time Tint as:
Tᵢₙₜ=Nₛₐₘₚₗₑₛ·Fₛ·N_{chirps}, where
Fs is the frequency at which the number samples is obtained.

17. The vehicle according to claim 16, wherein the processor is further configured to estimate a number of elements of the kernel as:
$${N}_{cells} = [ \frac{{T}_{int} {R}_{samples}}{{R}_{ma x}} d ] ,$$
the set of range values is from 0 to Rmax, which is a maximum unambiguous target range, Rsamples is a number of increments from 0 to Rmax, and d is a Doppler value within the set of Doppler values associated with the number of range values over which the energy levels above a threshold value are spread.

18. The vehicle according to claim 17, wherein each of the elements of the kernel has a value of 1/Ncells.

19. The vehicle according to claim 17, wherein the processor is configured to filter the range-Doppler map to obtain the result of the filtering by convolving the Rsamples number of energy levels associated with the Doppler value d with the Ncells number of elements of the kernel.

20. The vehicle according to claim 15, wherein the radar system is a multi-input multi-output (MIMO) radar system.
